(19) United States
(12) Patent Application Publication
(10) Pub. No.: US 2026/0093512 A1
(43) Pub. Date: Apr. 2, 2026

(54) LIGHTWEIGHT ROLLING UPDATE TECHNIQUE FOR APPLICATIONS

(71) Applicant: INTERNATIONAL BUSINESS MACHINES CORPORATION, ARMONK, NY (US)

(72) Inventors: Qi Feng Huo, Beijing (CN); Da Li Liu, Beijing (CN); Yuan Yuan Wang, Beijing (CN); Lei Li, Beijing (CN); Yan Song Liu, Beijing (CN)

(21) Appl. No.: 18/888,904

(22) Filed: Sep. 18, 2024

(51) Int. Cl. G06F 9/455; G06F 11/30

(52) U.S. Cl. CPC G06F 9/45558; G06F 11/302; G06F 2009/45562; G06F 2009/45591

(57) ABSTRACT

Provided are techniques for a lightweight rolling update technique for applications. It is determined that a monitored item of a pod has been updated based on monitoring a pod object associated with the pod, where the pod includes a container, and where the container includes an application. A policy is retrieved for the pod, where the policy identifies the container and specifies one or more actions to be performed on the container. The one or more actions are performed on the container. Annotations to the pod object are updated to indicate that the one or more actions have been completed.

### BACKGROUND

Embodiments of the invention relate to a lightweight rolling update technique for applications. For example, the applications may be cloud native applications.

For both public cloud and hybrid cloud, cloud native applications may be updated via a rolling update to avoid disruption. The cloud native applications may be stored in containers, which are stored in pods. The rolling update deletes some pods and recreates those pods, while keeping some other pods still running. It may take several hours to recreate all of the pods when rolling out new versions of the cloud native applications in production. Recreating the pods includes initializing Virtual Machines (VMs) and pulling images of the cloud native applications.

In addition, recreating pods consumes a lot of time because: a) pods usually are running in separate VM boundaries and initializing the VM takes a lot of time; and b) some computing requires pulling an image, and recreating the pods means images are pulled again. In a cloud environment, the image pull occurs on a node (i.e., a compute node) one time to create multiple pods. However, on a VM based pod, the image pull occurs for each of the multiple pods.

### SUMMARY

In accordance with certain embodiments, a computer-implemented method comprising operations is provided for a lightweight rolling update technique for applications. In such embodiments, It is determined that a monitored item of a pod has been updated based on monitoring a pod object associated with the pod, where the pod includes a container, and where the container includes an application. A policy is retrieved for the pod, where the policy identifies the container and specifies one or more actions to be performed on the container. The one or more actions are performed on the container. Annotations to the pod object are updated to indicate that the one or more actions have been completed.

In accordance with other embodiments, a computer program product comprising a computer readable storage medium having program code embodied therewith is provided, where the program code is executable by at least one computer processor to perform operations for a lightweight rolling update technique for applications. In such embodiments, It is determined that a monitored item of a pod has been updated based on monitoring a pod object associated with the pod, where the pod includes a container, and where the container includes an application. A policy is retrieved for the pod, where the policy identifies the container and specifies one or more actions to be performed on the container. The one or more actions are performed on the container. Annotations to the pod object are updated to indicate that the one or more actions have been completed.

In accordance with yet other embodiments, a computer system comprises one or more computer processors, one or more computer-readable memories and one or more computer-readable, tangible storage devices; and program instructions, stored on at least one of the one or more computer-readable, tangible storage devices for execution by at least one of the one or more computer processors via at least one of the one or more memories, to perform operations for a lightweight rolling update technique for applications. In such embodiments, It is determined that a monitored item of a pod has been updated based on monitoring a pod object associated with the pod, where the pod includes a container, and where the container includes an application. A policy is retrieved for the pod, where the policy identifies the container and specifies one or more actions to be performed on the container. The one or more actions are performed on the container. Annotations to the pod object are updated to indicate that the one or more actions have been completed.

### BRIEF DESCRIPTION OF THE DRAWINGS

Referring now to the drawings in which like reference numbers represent corresponding parts throughout:

FIG. 1A illustrates a computing environment with a pod rolling updater and an extension deployment controller in accordance with certain embodiments.

FIG. 1B illustrates a computing environment with a rolling update plugin in accordance with certain embodiments.

FIG. 2 illustrates a computing environment for lightweight rolling updates for applications in accordance with certain embodiments.

FIG. 3 illustrates further details of a pod in accordance with certain embodiments.

FIG. 4 illustrates an example Customer Resource Definition (CRD) policy in accordance with certain embodiments.

FIG. 5 illustrates a schema of a monitor section of a policy in accordance with certain embodiments.

FIG. 6 illustrates a schema of a subject portion of a policy in accordance with certain embodiments.

FIG. 7 illustrates a schema of an action portion of a policy in accordance with certain embodiments.

FIG. 8 illustrates a computing environment for implementing a policy in accordance with certain embodiments.

FIG. 9 illustrates a legacy pod update process in accordance with certain embodiments.

FIG. 10 illustrates annotations for a pod in accordance with certain embodiments.

FIGS. 11A and 11B illustrate, in a flowchart, operations for lightweight rolling updates to containers in pods in accordance with certain embodiments.

FIG. 12 illustrates, in a flowchart, operations for performing actions on a container in a pod without recreating the pod in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

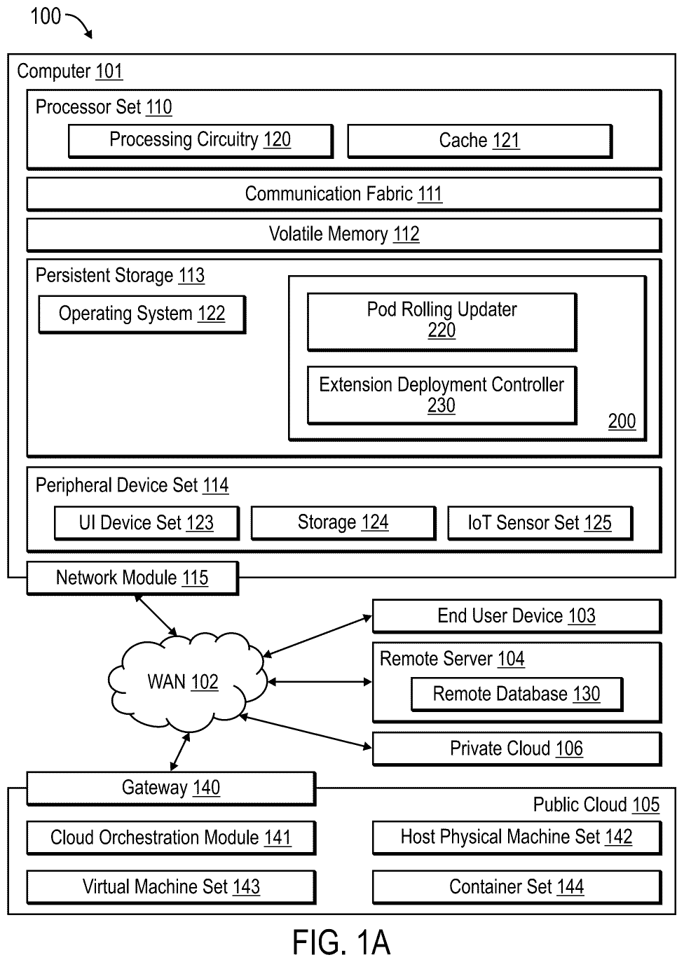

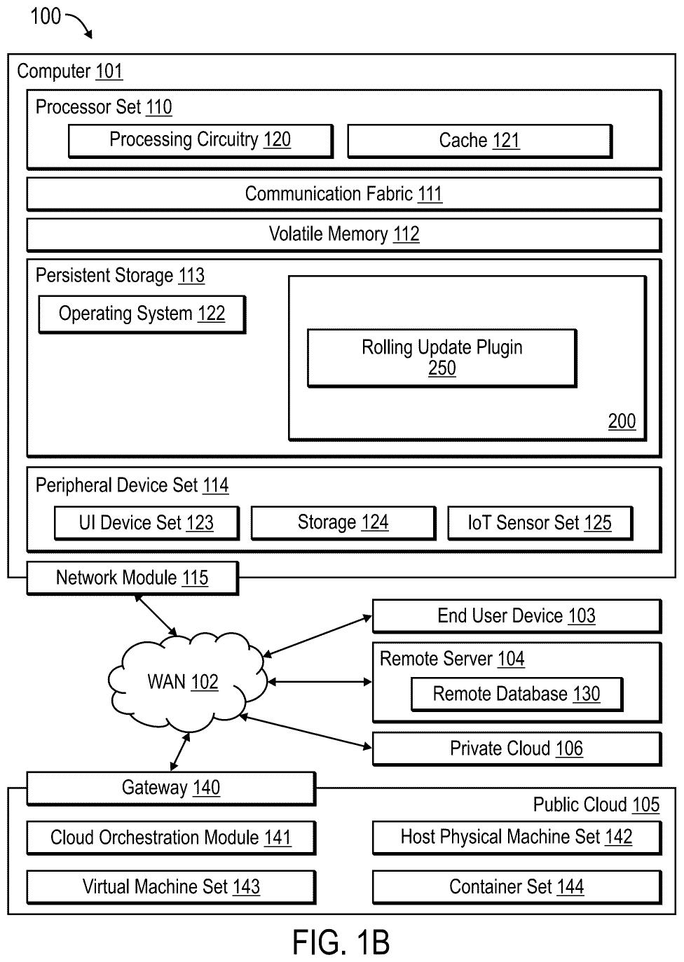

Computing environment 100 of FIG. 1A contains an example of an environment for the execution of at least some of the computer code involved in performing the inventive methods, such as a pod rolling updater 220 and an extension deployment controller 230 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1B is similar to FIG. 1A, but in FIB. 1b, the computing environment 100 of contains an example of an environment for the execution of at least some of the computer code involved in performing the inventive methods, such as a rolling update plugin of block 200.

Embodiments provide lightweight rolling updates for applications, such as cloud native applications, without recreating pods. A rolling update may be described as an incremental update in which update actions are taken on the pods one by one.

Embodiments of the invention update containers in pods, where the containers include the applications. Updating the containers also updates the applications.

Embodiments avoid recreating VMs and pulling images, and so embodiments improve the performance for rolling updates of the applications. The lightweight rolling update technique is a low overhead technique.

The following list of terms and their definitions are provided to enhance understanding of embodiments:

A container may be described as a namespace isolated and container group (cgroup) restricted application. A namespace enables organizing clusters into virtual sub-clusters. A cgroup enables efficient resource management, isolation, and monitoring. The container includes an application, such as a cloud native application.

An image may be described as ready-to-run software package of an application and its dependencies that contain everything used to run the application.

Pods may be described as collections of related containers. That is, a pod may include one or more containers. A pod shares network/storage among containers in the pod.

Initialization (init) containers may be described as ones that are run before the application containers are started in a pod. The init containers may include utilities or setup scripts that are not available in the application containers. Each application container includes an application.

A secret may be described as an object that contains a small amount of sensitive data and is associated with a pod.

A configmap may be described as an API object used to store non-confidential data in key-value pairs and is associated with a pod.

A deployment describes a desired state, and a deployment controller changes the actual state to the desired state at a controlled rate. The desired state may be described as a configuration of a pod and indicates the state of the pod (e.g., running, pending, complete, etc.).

A lightweight rolling update allows a deployment update to take place with no downtime to incrementally update pods (i.e., pod instances) by updating containers within the pods. The newly updated pods may be scheduled on nodes with available resources.

A secret container may be described as a secure container runtime with lightweight virtual machines that feel and perform like containers, but provide stronger workload isolation using hardware virtualization technology.

A confidential container may be described as enabling confidential computing (e.g., cloud native confidential computing) by leveraging Trusted Execution Environments (TEEs) to protect containers and data. In certain embodiments, use of “container”herein refers to a “confidential container”.

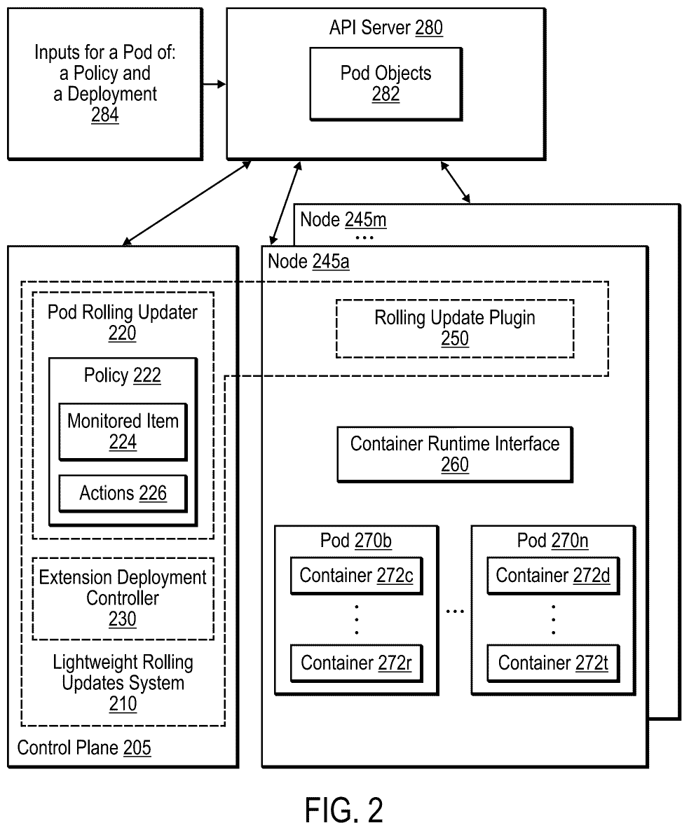

FIG. 2 illustrates a computing environment for lightweight rolling updates for applications in accordance with certain embodiments. In FIG. 2, an API server 280 is connected to a control plane 205 and to one or more nodes 245a . . . 245m. The API server 280 stores pod objects 282 and receives inputs for a pod of a policy and a deployment (i.e., a desired state) 284. The policy identifies a secret and/or a configmap 284 (i.e., a monitored item) to be monitored for an update and actions to be taken on containers when the monitored item is updated. Thus, the secret or the configmap may be described as a monitored item. In certain embodiments, a user (e.g., a system administrator) provides the inputs 284. In certain embodiments, a pod object may be described as a pod instance or as the descriptor or definition of the pod, and the pod object may be modified (e.g., by taking actions on the pod object). The policy and deployment may be provided in a data serialization language for different programming languages.

The control plane 205 may be implemented using the computer 101 of FIG. 1A. In certain embodiments, the control plane 205 is a virtual machine on the computer 101 of FIG. 1A. The control plane 205 includes a pod rolling updater 220 and an extension deployment controller 230. The pod rolling updater 220 includes a policy 222 with actions 224. The extension deployment controller 230 may be described as an extension to the deployment controller.

In certain embodiments, each of the nodes 245a . . . 245m may be implemented using the computer 101 of FIG. 1B. In certain embodiments, each of the nodes 245a . . . 245m is a virtual machine on the computer 101 of FIG. 1B. Each of the nodes 245a . . . 245m may have the components shown for node 245a. In particular, node 245a includes a rolling update plugin 250, a container runtime interface 260, and one or more pods 270b . . . 270n. Each pod includes one or more containers, and each of the containers includes an application (e.g., a cloud native application). For example, the pod 270b includes containers 272c . . . 272r, while the pod 270n includes containers 272d . . . 272t.

In certain embodiments, the control plane 205 and nodes 245a . . . 245m may be virtual machines on separate computers. In other embodiments, the control plane 205 and nodes 245a . . . 245m may be virtual machines on one computer.

The pod rolling updater 220, the extension deployment controller 230, and the rolling update plugin 250 together may be referred to as a lightweight rolling update system 210.

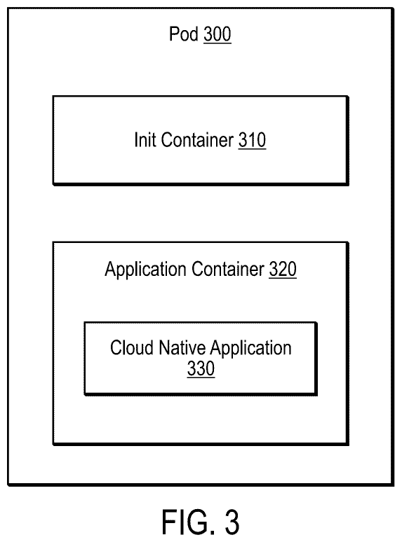

FIG. 3 illustrates further details of a pod 300 in accordance with certain embodiments. The pod 300 includes an init container 310 and an application container 320. The application container 320 includes a cloud native application (i.e., an example of an application). Updating the application container also updates the cloud native application. Each of pods 270b . . . 270n may take the form of pod 300.

Each container (in a pod) has its own path (e.g. /path/to/certificate_file) that points to a file on a node (e.g. /data/configure/container/network_certificate), and the volume (of storage) is set in the pod descriptor and/or the container descriptor.

With embodiments, the lightweight rolling update system 210 innovates a technique of low overhead, lightweight rolling updates, without recreating a pod completely. The lightweight rolling update system 210 introduces a new plugin, the rolling update plugin 250, to perform actions for a container that is automatically created by the rolling update plugin 250. With embodiments, a default policy is restarting each of the containers inside the pod, however, a user may optimize the default policies based on real cases. For example, when the environment or mount is changed, a user may specify a policy that says a subset of related containers are restarted (without restarting all of the containers). The environment or mount may be described as a configuration file or as one or more configuration parameters.

In certain embodiments, the lightweight rolling update system 210 provides a more granular rolling update technique based on containers. The rolling update plugin 250 performs lightweight rolling updates for pods. The lightweight rolling update system 210 enables defining a fine-grained group of container actions to be taken by the rolling update plugin 250. The lightweight rolling update system 210 enables a user to define a well-defined policy to trigger the container actions. The lightweight rolling update system 210 also enables automatic creation of policies and actions according to annotations of pods.

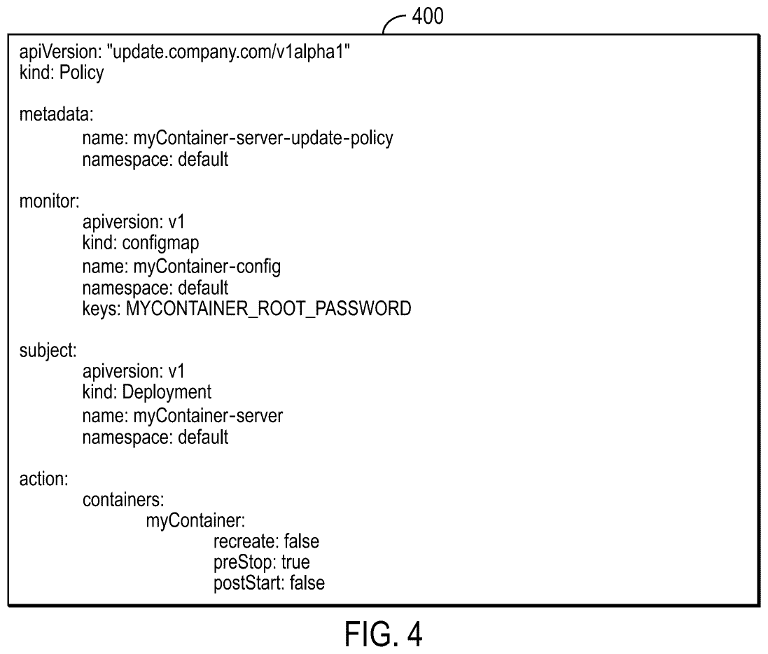

FIG. 4 illustrates an example Customer Resource Definition (CRD) policy 400 in accordance with certain embodiments. The CRD policy 400 defines a policy including: version “update.company.com/v1alpha1”, kind: Policy, and metadata (name and namespace). In addition, the policy 400 includes a monitor portion describing data to be monitored in a secret or a configmap; a subjects portion describing one or more subjects (e.g., deployment or pod); and an action portion describes actions to be taken to update a specified container (e.g., the recreate property is false; the prestop property is true; and the poststart property is false). The policy 400 may be described as a policy object. When the recreate property is true, the container is recreated; and, when the recreate property is false, the container is not recreated. When the preStop property is true, the action is performed before the container is stopped. When the postStart property is true, the action is performed after the container is started.

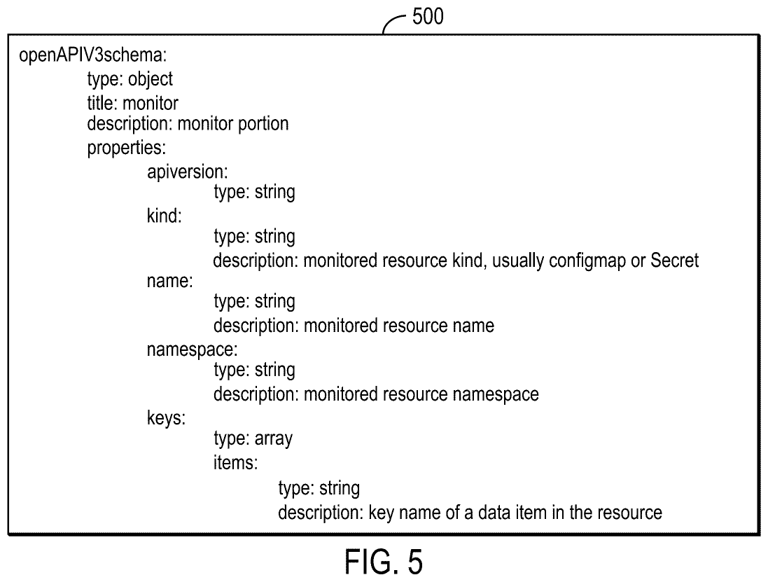

FIG. 5 illustrates a schema 500 of the monitor portion of a policy in accordance with certain embodiments. The schema 500 defines, for the monitor portion, properties of: APIversion, kind, name, namespace, and keys.

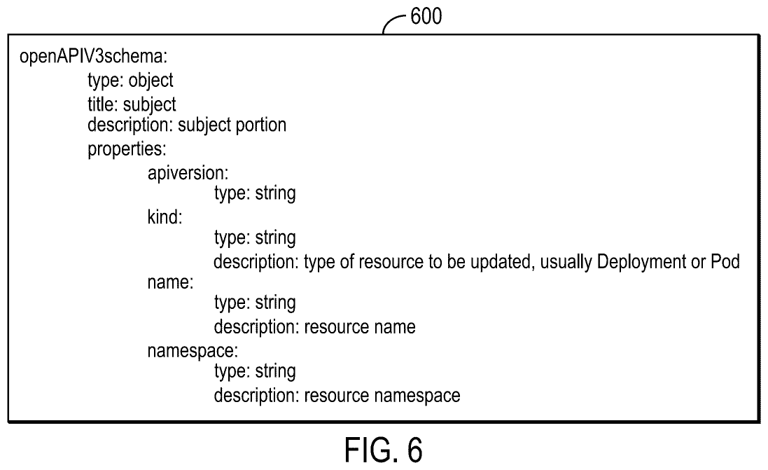

FIG. 6 illustrates a schema 600 of the subject portion of a policy in accordance with certain embodiments. The schema 600 defines, for the subject portion, properties of: APIversion, kind, name, and namespace.

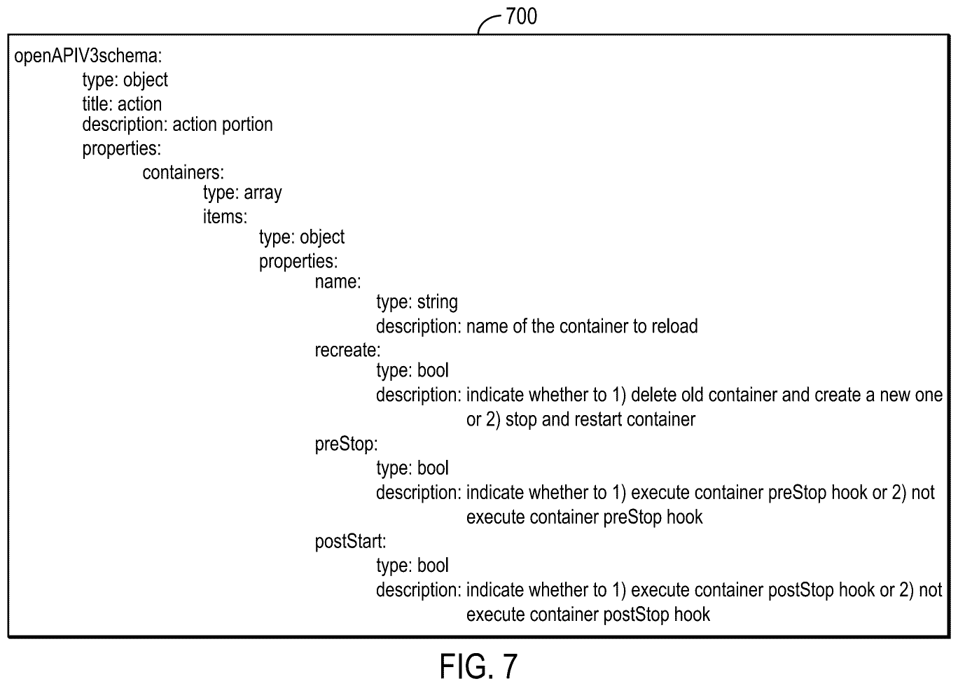

FIG. 7 illustrates a schema 700 of the action portion of a policy in accordance with certain embodiments. The schema 700 defines, for the action portion, properties of containers which have properties of: name, recreate, preStop, and postStart.

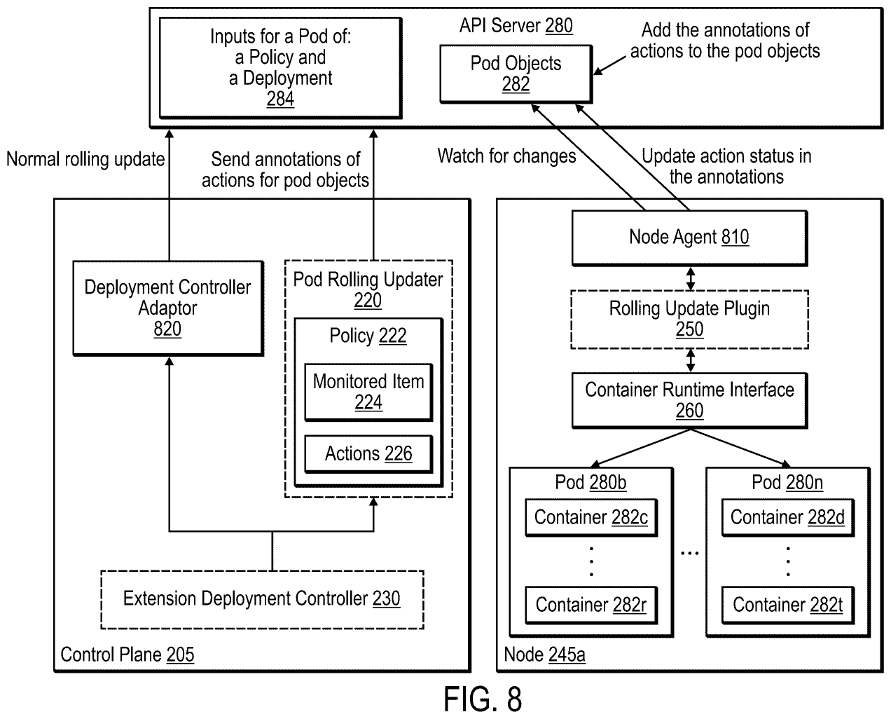

FIG. 8 illustrates a computing environment for implementing a policy in accordance with certain embodiments. In FIG. 8, one node 245a is illustrated, but there may be any number of nodes. The node 245a includes a node agent 810. The control plane 205 includes a deployment controller adaptor 820.

Initially, a user defines a deployment (i.e., a desired state), a secret and/or a configmap that are monitored by the extension deployment controller 230, and a policy with actions that are to be triggered when there is a lightweight rolling update. The API server 280 stores the policy and the deployment 284.

The user may create the deployment to a cluster. The deployment consists of pods, and each of the pods consists of at least two containers. One container is an init-container, while another container is an application container (e.g., for container myContainer in FIG. 4). The myContainer container includes environment variables defined by a secret.

Then, the user changes the deployment to either change the image or to change the secret or the configmap.

If the changes to the deployment result in the image (e.g., for a cloud native application or other application in a container) being changed, the extension deployment controller 230 calls the deployment controller adaptor 820 to start a legacy (i.e., normal or conventional) pod update process. However, if the changes to the deployment result in the items of a pod object that are monitored being changed (e.g., the secret or the configmap), the extension deployment controller 230 calls the pod rolling updater 220.

The pod rolling updater 220 updates (i.e., annotates) the pod object with the action that is to be taken. In certain embodiments, the pod rolling updater 220 sends the annotations of actions for pod objects to the API server 280. The API server 280 adds the annotations of actions to the pod objects.

The node agent 810 monitors the pod objects 282 and determines, from the annotations, that there is an action to be taken.

Then, the node agent 810 triggers the related pre-defined actions (i.e., actions for one or more containers in a policy associated with the pod). The action may be: to restart an app container (e.g., the myContainer container), to reload an environment of a secret (e.g., to reload a configuration file or one or more configuration parameters), recreate an init-container and app container in sequence, or trigger some other container lifecycle hook.

When the action is completed, the rolling update plugin 250 notifies the node agent 810, and the node agent 810 updates the annotations to a pod object 282 to indicate that the action has been performed.

The container runtime interface 260 creates containers in memory. The container runtime interface 260 also sends instructions to the pod objects to take actions.

The pod rolling updater 220 determines that the action of the pod object 282 is marked as done and continues to handle another pod object.

In particular, the node agent 810 triggers the rolling update plugin 250 based on determining that there is an action to be taken. The rolling update plugin 250 gets a policy with actions for the pod associated with the pod object that has been annotated. In certain embodiments, the rolling update plugin 250 creates the policy with actions automatically according to the annotations of the pod object. In other embodiments, the rolling update plugin 250 retrieves an existing policy with actions for the pod associated with the annotated pod object. The rolling update plugin 250 performs the actions in the policy. Examples of the actions include: StopContainer to stop executing the application in the container, StartContainer to start executing the application in the container, RemoveContainer to remove the container from the pod object (while keeping the pod object), and CreateContainer to create a container in the pod object.

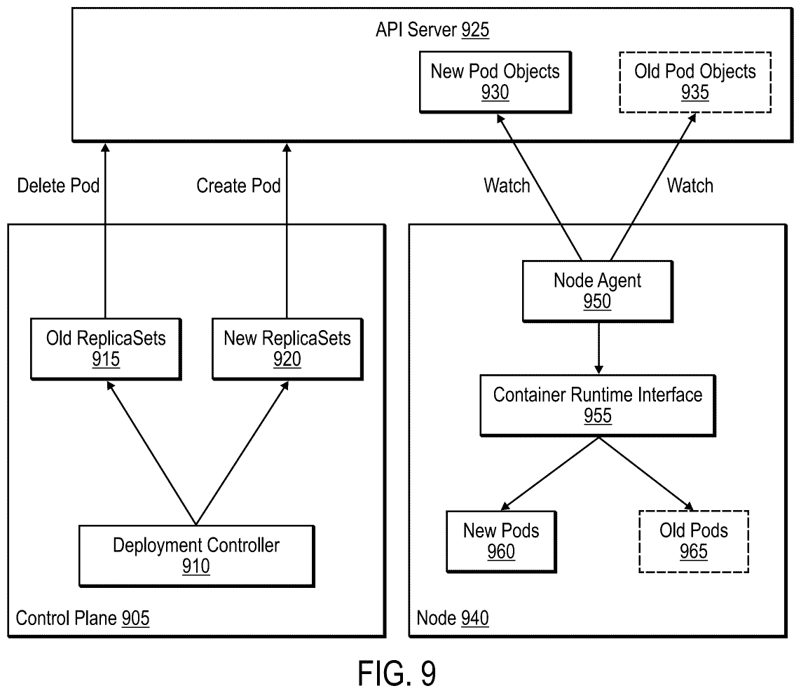

FIG. 9 illustrates a legacy pod update process in accordance with certain embodiments. In the control plane 905, the deployment controller 910 is connected to the old replicasets 915 and to the new replicasets 920. In the legacy embodiment, an old pod object is deleted and a new pod object is created (rather than just performing an operation on a container). In the node 940, the node agent 950 watches the new pod objects 930 and the old pod objects 935 on the API server 925 for actions (e.g., a create action).

Then, the container runtime interface 955 performs: RunPodSandbox, CreateContainer, and StartContainer for the new pods. Also, the container runtime interface 955 performs: StopContainer, RemoveContainer, and RemovePodSandbox for the old pod.

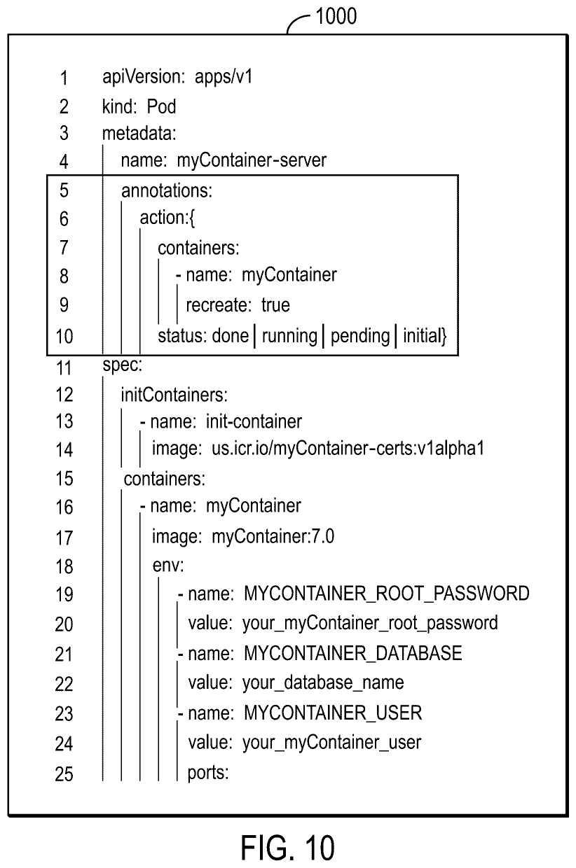

FIG. 10 illustrates annotations 1000 for a pod in accordance with certain embodiments. In the annotations 1000, the action for the myContainer container is recreate. At various points in time, the recreate action has a status of: done, running, pending or initial.

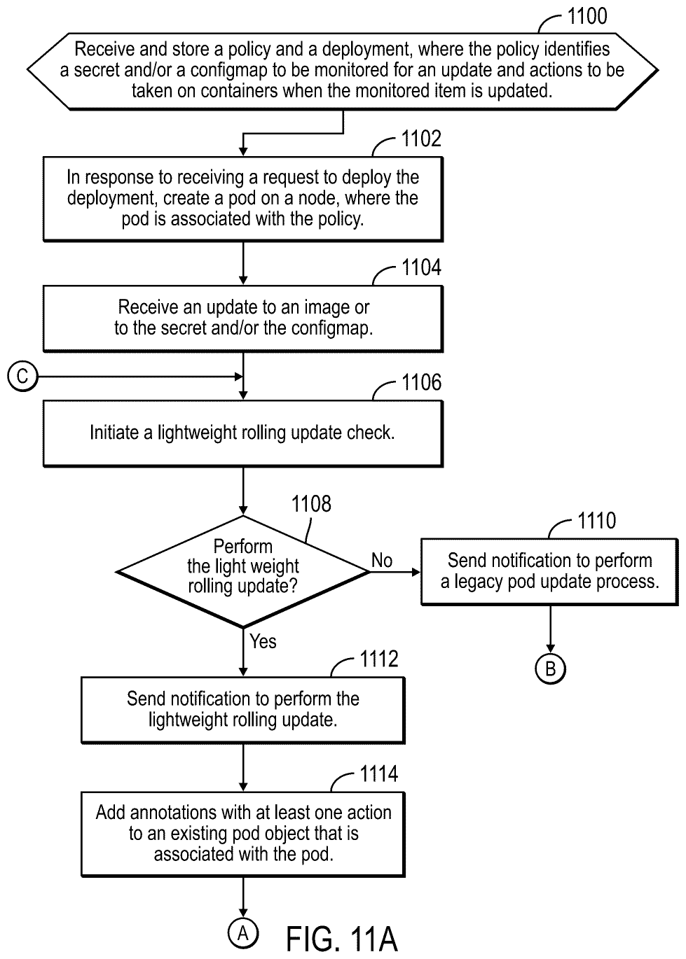

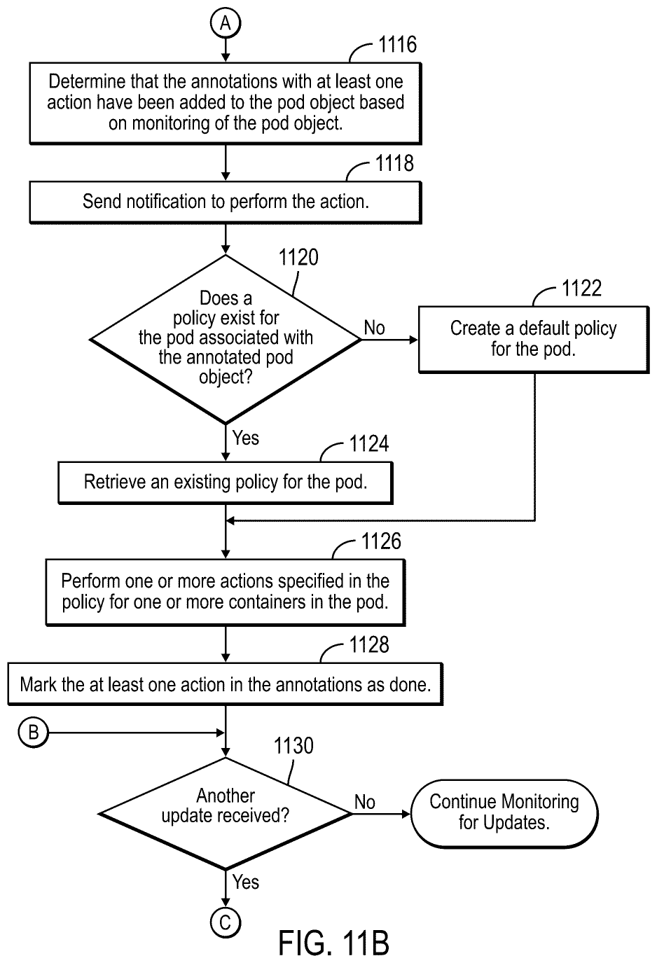

FIGS. 11A and 11B illustrate, in a flowchart, operations for lightweight rolling updates to containers in pods in accordance with certain embodiments. Control begins at block 1100 with the API server 280 receiving (from a user) and storing a policy and a deployment, where the policy identifies a secret and/or a configmap to be monitored for an update and actions to be taken on containers when the monitored item is updated. In block 1102, in response to receiving a request to deploy the deployment, the API server 280 creates the pod on a node. The pod includes at least an init container and an application container. The application container includes an application.

In block 1104, the extension deployment controller 230 receives an update to an image (of an application in a container of a pod) or receives an update to the secret and/or the configmap.

In block 1106, the extension deployment controller 230 initiates a lightweight rolling update check. In block 1108, the extension deployment controller 230 determines whether to perform a lightweight rolling update. If the lightweight rolling update is to be performed, processing continues to block 1112, otherwise, processing continues to block 1110. In certain embodiments, if an image of an application in a container of a pod is updated, then the legacy pod update process is performed, while, if a monitored item (i.e., a secret or a configmap) is updated, the lightweight rolling update is performed.

In block 1110, the extension deployment controller 230 notifies the deployment controller adaptor 720 to perform the legacy pod update process. Once the legacy pod update process completes, from block 1110 (FIG. 11A), processing continues to block 1130 (FIG. 11B).

In block 1112, the extension deployment controller 230 notifies the pod rolling updater 220 to perform the lightweight rolling update.

In block 1114, the pod rolling updater 220 adds annotations with at least one action to an existing pod object that is associated with the pod. In certain embodiments, the pod rolling updater 220 identifies the policy associated with the pod, determines one or more actions for the one or more containers in the pod, and annotates the pod object with information, including at least one of the actions. From block 1114 (FIG. 11A), processing continues to block 1116 (FIG. 11B).

In block 1116, the node agent 710 identifies that the annotations with the at least one action has been added to the pod object based on monitoring of the pod object. In block 1118, the node agent 710 sends a notification to the rolling update plugin 250 to perform the action.

In block 1120, the rolling update plugin 250 determines whether a policy exists for the pod associated with the annotated pod object. If yes, processing continues to block 1124, otherwise, processing continues to block 1122.

In block 1122, the rolling update plugin 250 creates a default policy with actions for the pod. For example, the default policy may indicate that the containers in the pod object are to be recreated. In certain embodiments, the rolling update plugin 250 creates the default policy based on the annotations. The default policy may be stored for future use. From block 1122, processing continues to block 1126.

In block 1124, the rolling update plugin 250 retrieves an existing policy for the pod.

In block 1126, the rolling update plugin 250 performs one or more actions specified in the policy for one or more containers in the pod (e.g., the application container). The policy is either the default policy (block 1122) or the existing policy (block 1124). In block 1128, the rolling update plugin 250 marks the at least one action in the annotations as done. In certain embodiments, the container runtime interface 260 notifies the rolling update plugin 250 that the actions are done, the rolling update plugin 250 notifies the node agent 810 that the actions are done, and the node agent 810 marks the actions in the annotations as done.

In block 1130, the extension deployment controller 230 determines whether another update has been received. If yes, processing continue to block 1106, otherwise, monitoring/waiting for another update continues.

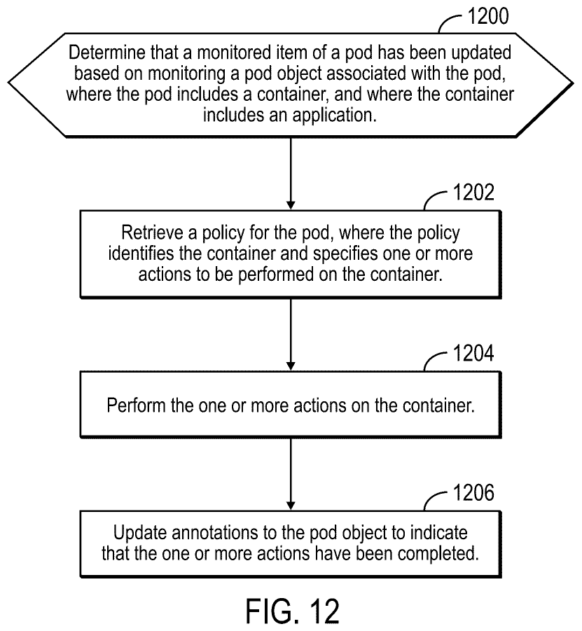

FIG. 12 illustrates, in a flowchart, operations for performing actions on a container in a pod without recreating the pod in accordance with certain embodiments.

Control begins at block 1200 with the lightweight rolling update system 210 determining that a monitored item of a pod has been updated based on monitoring a pod object associated with the pod (where the monitoring identifies new annotations to the pod object), where the pod includes a container, and where the container includes an application (e.g., a cloud native application). In block 1202, the lightweight rolling update system 210 retrieves a policy for the pod, where the policy identifies the container and specifies one or more actions to be performed on the container. In block 1204, the lightweight rolling update system 210 performs the one or more actions on the container. By performing the one or more actions on the container, the lightweight rolling update system 210 performs the one or more actions on the application. For example, if the container is restarted, the application is restarted. In block 1206, the lightweight rolling update system 210 updates annotations to the pod object to indicate that the one or more actions have been completed.

In certain embodiments, the monitored item is an item selected from a group consisting of a secret and a configmap. In certain embodiments, the one or more actions are selected from a group consisting of creating a new container, deleting an existing container, executing the existing container with a preStop property (i.e., a preStop hook), and executing the existing container with a postStart property (i.e., a postStart hook).

In certain embodiments, the lightweight rolling update system 210 adds the annotations to the pod object, where the annotations comprise an identifier of the container, the one or more actions, and a status of each of the one or more actions.

In certain embodiments, the lightweight rolling update system 210, for another pod, determines that a policy has not been created and creates a default policy with actions for a container in that pod.

In certain embodiments, the one or more actions are performed for the container without recreating the pod object.

In certain embodiments, the policy comprises the monitored item, related subjects (e.g., a deployment or a pod), and the one or more actions.

Thus, the lightweight rolling update system 210 provides a lightweight update of a pod by introducing a new granularity of pod update. With the lightweight rolling update system 210, since containers in a pod are restarted, without pod recreation, images are not pulled again for the pod, virtual machines are not created for the pod, etc. In addition, the lightweight rolling update system 210 saves time by avoiding pod recreation, which is especially useful for secret containers and confidential containers.

Also, with embodiments, the lightweight rolling update may be completed in minutes (instead of hours), which minimizes disruption to use of the applications.

Confidential Artificial Intelligence (AI) computing may use confidential containers, which are stored in a pod. In confidential AI, usually, model hyperparameters for a confidential container are changed to tune an AI model, while the AI model code image and the AI model are kept unchanged. With embodiments, instead of updating (i.e., recreating) the pod storing the confidential container, the lightweight rolling update updates the confidential container for the changed model hyperparameters to take effect. Some examples of model hyperparameters include: the learning rate for training a neural network, the C and sigma hyperparameters for support vector machines, and the k in k-nearest neighbors.

Confidential AI also exposes web Application Programming Interfaces (APIs). In this case, certificates are used to guarantee service integrity, which are mount as volume from configmap. To rotate the certificates, the configmap is changed. With embodiments, instead of updating (i.e., recreating) the pod to sync the changed configmap to the pod, the lightweight rolling update updates one or more containers in the pod.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)”unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method, comprising operations for:
determining that a monitored item of a pod has been updated based on monitoring a pod object associated with the pod, wherein the pod includes a container, and wherein the container includes an application;
retrieving a policy for the pod, wherein the policy identifies the container and specifies one or more actions to be performed on the container;
performing the one or more actions on the container; and
updating annotations to the pod object to indicate that the one or more actions have been completed.

2. The computer-implemented method of claim 1, wherein the monitored item is an item selected from a group consisting of a secret and a configmap.

3. The computer-implemented method of claim 1, wherein the one or more actions are selected from a group consisting of creating a new container, deleting an existing container, executing the existing container with a preStop property, and executing the existing container with a postStart property.

4. The computer-implemented method of claim 1, wherein the operations further comprise:
adding the annotations to the pod object, wherein the annotations comprise an identifier of the container, the one or more actions, and a status of each of the one or more actions.

5. The computer-implemented method of claim 1, wherein the operations further comprise:
for another pod, determining that a policy has not been created; and
creating a default policy with actions for a container in that pod.

6. The computer-implemented method of claim 1, wherein the one or more actions are performed for the container without recreating the pod object.

7. The computer-implemented method of claim 1, wherein the policy comprises the monitored item, related subjects, and the one or more actions.

8. A computer program product comprising:
one or more computer-readable storage media; and
program instructions stored on the one or more storage media to perform operations comprising:
determining that a monitored item of a pod has been updated based on monitoring a pod object associated with the pod, wherein the pod includes a container, and wherein the container includes an application;
retrieving a policy for the pod, wherein the policy identifies the container and specifies one or more actions to be performed on the container;
performing the one or more actions on the container; and
updating annotations to the pod object to indicate that the one or more actions have been completed.

9. The computer program product of claim 8, wherein the monitored item is an item selected from a group consisting of a secret and a configmap.

10. The computer program product of claim 8, wherein the one or more actions are selected from a group consisting of creating a new container, deleting an existing container, executing the existing container with a preStop property, and executing the existing container with a postStart property.

11. The computer program product of claim 8, wherein the operations further comprise:
adding the annotations to the pod object, wherein the annotations comprise an identifier of the container, the one or more actions, and a status of each of the one or more actions.

12. The computer program product of claim 8, wherein the operations further comprise:
for another pod, determining that a policy has not been created; and
creating a default policy with actions for a container in that pod.

13. The computer program product of claim 8, wherein the one or more actions are performed for the container without recreating the pod object.

14. The computer program product of claim 8, wherein the policy comprises the monitored item, related subjects, and the one or more actions.

15. A computer system comprising:
a processor set;
one or more computer-readable storage media; and
program instructions stored on the one or more storage media to cause the processor set to perform operations comprising:
determining that a monitored item of a pod has been updated based on monitoring a pod object associated with the pod, wherein the pod includes a container, and wherein the container includes an application;
retrieving a policy for the pod, wherein the policy identifies the container and specifies one or more actions to be performed on the container;
performing the one or more actions on the container; and
updating annotations to the pod object to indicate that the one or more actions have been completed.

16. The computer system of claim 15, wherein the monitored item is an item selected from a group consisting of a secret and a configmap.

17. The computer system of claim 15, wherein the one or more actions are selected from a group consisting of creating a new container, deleting an existing container, executing the existing container with a preStop property, and executing the existing container with a postStart property.

18. The computer system of claim 15, wherein the operations further comprise:
adding the annotations to the pod object, wherein the annotations comprise an identifier of the container, the one or more actions, and a status of each of the one or more actions.

19. The computer system of claim 15, wherein the operations further comprise:
for another pod, determining that a policy has not been created; and
creating a default policy with actions for a container in that pod.

20. The computer system of claim 15, wherein the one or more actions are performed for the container without recreating the pod object.
